(19) United States
(12) Patent Application Publication
(10) Pub. No.: US 2016/0180400 A1
(43) Pub. Date: Jun. 23, 2016

(54) SYSTEMS AND METHODS FOR CREATING, SELECTING, PRESENTING, AND EXECUTING CALLS TO ACTION

(71) Applicant: Facebook, Inc., Menlo Park, CA (US)

(72) Inventors: David Shein, San Francisco, CA (US); Dong Guo, Milpitas, CA (US); Lacie Rhodes, San Francisco, CA (US); Kelly B. Winters, San Francisco, CA (US); Tony Hsien-yu Liu, Palo Alto, CA (US); Jing Zou, New York, NY (US); Eyal Michael Sharon, San Francisco, CA (US)

(21) Appl. No.: 14/577,568

(22) Filed: Dec. 19, 2014

(51) Int. Cl. G06Q 30/02; G06Q 50/00; H04L 29/06

(52) U.S. Cl. CPC G06Q 30/0269; H04L 65/403; G06Q 50/01

(57) ABSTRACT

Systems, methods, and non-transitory computer-readable media can acquire information associated with a user who is accessing a page within a social networking system. The page can be associated with a page entity. At least one call to action can be selected, out of a set of calls to action, based at least in part on the information associated with the user. The at least one call to action can be associated with the page entity. The at least one call to action can be presented to the user via the page within the social networking system. A user interaction performed with respect to the at least one call to action can be detected. An operation associated with the at least one call to action can be executed. The operation can correspond to one of a plurality of operations executable for the at least one call to action.

### FIELD OF THE INVENTION

The present technology relates to the field of online user experiences. More particularly, the present technology relates to techniques for creating, selecting, presenting, and executing calls to action.

### BACKGROUND

Today, people often utilize computing devices (or systems) for a wide variety of purposes. Users can use their computing devices to, for example, interact with one another, create content, share information, and access information. In some instances, a user can utilize his or her computing device to engage with businesses, utilize web resources, and access information about various subjects that may be of interest to the user.

In one example, the user can utilize the computing device to access a social networking system (or service) and view information about a page within the social networking system. However, under conventional approaches, only limited functionality can be provided to the user via the page within the social networking system. In another example, the user can use the computing device to browse online and encounter a call to action (CTA) while browsing online. However, conventional approaches to utilizing calls to action (CTA's) can be uninteresting, irrelevant, or not adequately interactive. These and other similar concerns can reduce or create challenges for the overall user experience associated with using computing devices in online environments.

### SUMMARY

Various embodiments of the present disclosure can include systems, methods, and non-transitory computer readable media configured to acquire information associated with a user who is accessing a page within a social networking system. The page can be associated with a page entity. At least one call to action can be selected, out of a set of calls to action, based at least in part on the information associated with the user. The at least one call to action can be associated with the page entity. The at least one call to action can be presented to the user via the page within the social networking system.

In an embodiment, the selecting of the at least one call to action can further comprise determining, based at least in part on the information associated with the user, a respective user relevance probability metric for each call to action in the set of calls to action. It can be determined that one or more calls to action are associated with one or more respective user relevance probability metrics that at least meet a specified user relevance probability threshold. The at least one call to action can be identified to include the one or more calls to action associated with the one or more respective user relevance probability metrics that at least meet the specified user relevance probability threshold.

In an embodiment, the information associated with the user can indicate at least one of an identity of the user, a gender of the user, an age of the user, a location associated with the user, an educational institution associated with the user, a professional institution associated with the user, a language associated with the user, or a relationship status of the user.

In an embodiment, the information associated with the user can include historical data associated with the user. The historical data can be associated with at least one of a browsing history of the user, an application usage history of the user, or a social networking system usage history of the user.

In an embodiment, the social networking system usage history of the user can indicate one or more social interactions performed by the user with respect to at least one content item posted via the social networking system.

In an embodiment, the one or more social interactions can include at least one of an up-vote, a comment, a share, or a save.

In an embodiment, the information associated with the user can indicate that the user is part of a particular defined audience. The selecting of the at least one call to action can be further based at least in part on selection criteria. The selection criteria can specify that the at least one call to action is to be selected for the particular defined audience.

In an embodiment, the information associated with the user can be dynamically acquired. The information associated with the user can include one or more updates. The selecting of the at least one call to action can be performed dynamically based on the one or more updates.

In an embodiment, the presenting of the at least one call to action can include displaying the at least one call to action in association with at least one interactive element. The at least one interactive element can be displayed within at least one of a cover photo of the page, an informational section of the page, a post published on the page, a hover element associated with the page, a search bar element associated with the page, or a search result element associated with the page.

In an embodiment, the presenting of the at least one call to action can be performed using at least one of a website configured to communicate with the social networking system or an application configured to communicate with the social networking system.

Moreover, various embodiments of the present disclosure can include systems, methods, and non-transitory computer readable media configured to present, via a page within a social networking system, at least one call to action to a user who is accessing the page. A user interaction performed with respect to the at least one call to action can be detected. An operation associated with the at least one call to action can be executed. The operation can correspond to one of a plurality of operations executable for the at least one call to action.

In an embodiment, one or more instructions can be acquired from a page entity associated with the page. The operation can be selected out of the plurality of operations based at least in part on the one or more instructions from the page entity. The operation can be caused to be executed in response to the detecting of the user interaction performed with respect to the at least one call to action.

In an embodiment, the plurality of operations can include at least one of a link navigation operation, a native operation integrated with the social networking system, or a third party operation implemented by a third party operable with the social networking system.

In an embodiment, the operation can correspond to the link navigation operation. The link navigation operation can be associated with a specified link. The executing of the operation can include navigating to the specified link.

In an embodiment, the operation can correspond to the native operation integrated with the social networking system. The executing of the operation can include providing access to at least one of an application or a service integrated with the social networking system.

In an embodiment, the operation can correspond to the third party operation implemented by the third party operable with the social networking system. The executing of the operation can include providing access to at least one of a third party application or a third party service.

In an embodiment, information associated with the user can be acquired. The operation can be selected out of the plurality of operations based at least in part on at least a portion of the information associated with the user.

In an embodiment, information associated with the user can be acquired. At least a portion of the information associated with the user can be utilized in the executing of the operation.

In an embodiment, an identifier of the user can be acquired. The user can be signed, based at least in part on the identifier, into an account of the user with at least one of an application or a service associated with the at least one call to action.

In an embodiment, information associated with the account of the user can be provided to the user via the page.

It should be appreciated that many other features, applications, embodiments, and/or variations of the disclosed technology will be apparent from the accompanying drawings and from the following detailed description. Additional and/or alternative implementations of the structures, systems, non-transitory computer readable media, and methods described herein can be employed without departing from the principles of the disclosed technology.

### BRIEF DESCRIPTION OF THE DRAWINGS

FIG. 1 illustrates an example system including an example social networking call to action (CTA) module configured to facilitate creating, selecting, presenting, and executing calls to action, according to an embodiment of the present disclosure.

FIG. 2A illustrates an example call to action (CTA) selection module configured to facilitate selecting calls to action, according to an embodiment of the present disclosure.

FIG. 2B illustrates an example call to action (CTA) presentation module configured to facilitate presenting calls to action, according to an embodiment of the present disclosure.

FIG. 2C illustrates an example call to action (CTA) execution module configured to facilitate executing calls to action, according to an embodiment of the present disclosure.

FIG. 3 illustrates an example scenario associated with utilizing calls to action, according to an embodiment of the present disclosure.

FIG. 4 illustrates an example scenario associated with utilizing calls to action, according to an embodiment of the present disclosure.

FIG. 5A illustrates an example method associated with utilizing calls to action, according to an embodiment of the present disclosure.

FIG. 5B illustrates an example method associated with utilizing calls to action, according to an embodiment of the present disclosure.

FIG. 6A illustrates an example method associated with utilizing calls to action, according to an embodiment of the present disclosure.

FIG. 6B illustrates an example method associated with utilizing calls to action, according to an embodiment of the present disclosure.

FIG. 7 illustrates a network diagram of an example system including an example social networking system that can be utilized in various scenarios, according to an embodiment of the present disclosure.

FIG. 8 illustrates an example of a computer system or computing device that can be utilized in various scenarios, according to an embodiment of the present disclosure.

The figures depict various embodiments of the disclosed technology for purposes of illustration only, wherein the figures use like reference numerals to identify like elements. One skilled in the art will readily recognize from the following discussion that alternative embodiments of the structures and methods illustrated in the figures can be employed without departing from the principles of the disclosed technology described herein.

### DETAILED DESCRIPTION

### Creating, Selecting, Presenting, and Executing Calls to Action

People use computing devices (or systems) for a wide variety of purposes. Computing devices can provide different kinds of functionality. Users can utilize their computing devices to produce information, access information, and share information. In some cases, people can utilize their computing devices to browse online (or web) resources, view details associated with businesses, make purchases online, make reservations at restaurants, and/or access and utilize other information.

In one example, a user can utilize his or her computing device to browse through various online resources. Under conventional approaches, during the browsing, the user can be presented with one or more forms of advertising or marketing, such as calls to actions. The calls to actions can attempt to encourage the user to take certain actions. For example, one type of call to action can encourage the user to make a purchase, such as to buy a product or service from an e-commerce storefront. However, under conventional approaches, the calls to actions and other similar advertising or marketing materials may be uninteresting or irrelevant to the user. Moreover, in accordance with conventional approaches, if the user clicks, taps, or otherwise engages with a call to action, the user may be burdened with numerous tasks in pursuit of the original call to action. For example, when a user selects a call to action to purchase an item, the user may be taken to a particular link for the e-commerce storefront, but still may need to perform a significant number of additional actions in order to complete the purchase. As such, conventional approaches to providing online experiences in connection with calls to action can be uninteresting, irrelevant, and inefficient.

In another example, the user can use the computing device to engage with a social networking system (or service). In this example, the user can view, access, or interact with one or more pages associated with entities within the social networking system, including various types of content made available via the one or more pages. However, under conventional approaches, only a limited amount and variety of content and interactivity may be presented via the one or more pages. As a result, interactions involving the user and the entities may be significantly limited, potentially impeding the full development of relationships between them. These and other similar concerns can reduce the overall user experience associated with social networking systems.

Therefore, an improved approach can be beneficial for addressing or alleviating various concerns associated with conventional approaches. The disclosed technology can offer a more interesting, relevant, interactive, and efficient approach. The disclosed technology can facilitate creating, selecting, presenting, and executing calls to action (CTA's), as described in more detail herein. Various embodiments of the present disclosure can acquire information associated with a user who is accessing a page within a social networking system. The page can be associated with a page entity. At least one call to action can be selected, out of a set of calls to action, based at least in part on the information associated with the user. The at least one call to action can be associated with the page entity. The at least one call to action can be presented to the user via many surfaces within the social networking system and outside the social networking system, such as the page within the social networking system. Various embodiments of the present disclosure can also detect a user interaction performed with respect to the at least one call to action. An operation associated with the at least one call to action can be executed. The operation can correspond to one of a plurality of operations executable for the at least one call to action. It is contemplated that there can be many variations and/or other possibilities.

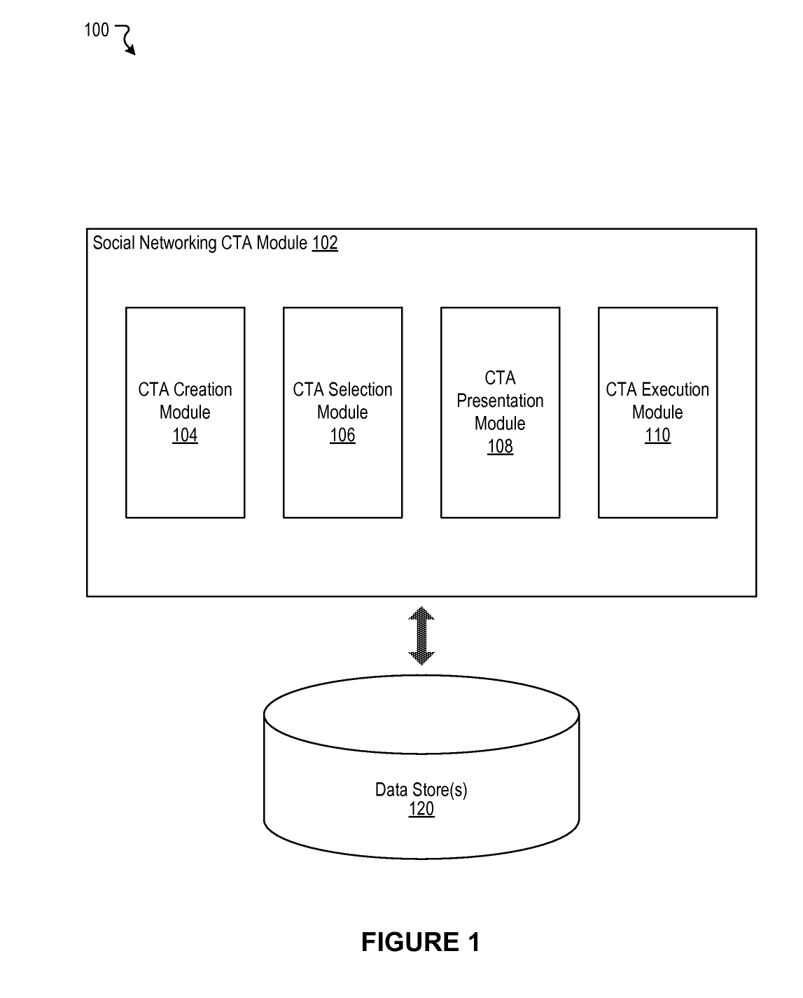

FIG. 1 illustrates an example system 100 including an example social networking call to action (CTA) module 102 configured to facilitate creating, selecting, presenting, and executing calls to action, according to an embodiment of the present disclosure. As shown in the example of FIG. 1, the example social networking CTA module 102 can include a call to action (CTA) creation module 104, a call to action (CTA) selection module 106, a call to action (CTA) presentation module 108, and a call to action (CTA) execution module 110. In some instances, the example system 100 can include at least one data store 120. The components (e.g., modules, elements, etc.) shown in this figure and all figures herein are exemplary only, and other implementations may include additional, fewer, integrated, or different components. Some components may not be shown so as not to obscure relevant details.

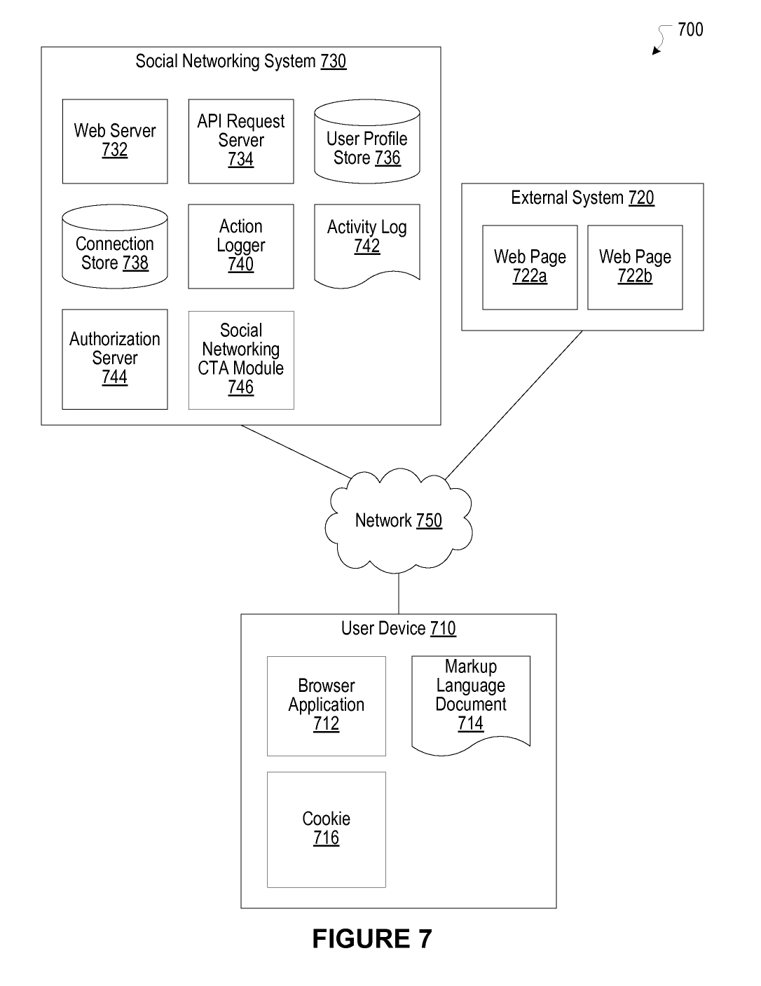

In some embodiments, the social networking CTA module 102 can be implemented, in part or in whole, as software, hardware, or any combination thereof. In general, a module as discussed herein can be associated with software, hardware, or any combination thereof. In some implementations, one or more functions, tasks, and/or operations of modules can be carried out or performed by software routines, software processes, hardware, and/or any combination thereof. In some cases, the social networking CTA module 102 can be implemented, in part or in whole, as software running on one or more computing devices or systems, such as on a user or client computing device. For example, the social networking CTA module 102 or at least a portion thereof can be implemented as or within an application (e.g., app), a program, or an applet, etc., running on a user computing device or a client computing system, such as the user device 710 of FIG. 7. In another example, the social networking CTA module 102 or at least a portion thereof can be implemented using one or more computing devices or systems that include one or more servers, such as network servers or cloud servers. In some instances, the social networking CTA module 102 can, in part or in whole, be implemented within or configured to operate in conjunction with a social networking system (or service), such as the social networking system 730 of FIG. 7. It should be understood that there can be many variations or other possibilities.

The CTA creation module 104 can be configured to facilitate creating one or more calls to actions for one or more surfaces, such as pages, supported by the social networking system. In some instances, the CTA creation module 104 can enable one or more calls to action to be created for a page in order to facilitate more potential interaction between the page and users that visit the page. The creation of the one or more calls to action can be customized for the page (e.g., customized based on information about the page and/or about users who view or access the page). In some cases, the CTA creation module 104 can enable an entity associated with the page (i.e., page entity), such as a page admin, a page representative, a business or brand represented by the page, to customize the page by creating one or more calls to action that can be different from calls to action of other pages. The one or more calls to action can sometimes be created in attempt to satisfy one or more objectives (e.g., marketing goals, business needs, etc.) of the page and/or the page entity. For example, if the page desires to sell a particular product or service, a call to action can be created on the page to enable users viewing or accessing the page to more easily purchase the particular product or service, such as by clicking, tapping, selecting, or otherwise interacting with the call to action.

In some embodiments, the CTA creation module 104 can create calls to action using a set of predefined or default calls to action. For example, the set of predefined or default calls to action can include, but is not limited to, a “Buy Now” call to action (e.g., for a product), a “Shop Now” call to action, a “Pay Now” call to action (e.g., for a financial transaction), a “Book Now” call to action (e.g., for a ticket), a “Reserve Now” call to action (e.g., for a restaurant), a “Sign Up” call to action (e.g., for a service), a “Log In” call to action (e.g., for providing information after authentication), a “Watch Now” call to action (e.g., for a media content item), a “View Now” call to action (e.g., for seeing information), a “Contact Us” call to action (e.g., for inviting further communication), a “Install Now” call to action (e.g., for software), a “Go to App” call to action (e.g., for additional functionality), a “Play Now” call to action (e.g., for a game), a “Like This” call to action (e.g., for sharing satisfaction with others), a “See More” call to action (e.g., for accessing more information), and a “More Info” call to action (e.g., for accessing more information), etc. In general, the CTA creation module 104 can create other calls to action relating to any action that may be taken by a user, as desired by the user, a page, or the social networking system. It is contemplated that there can be many variations and other possibilities.

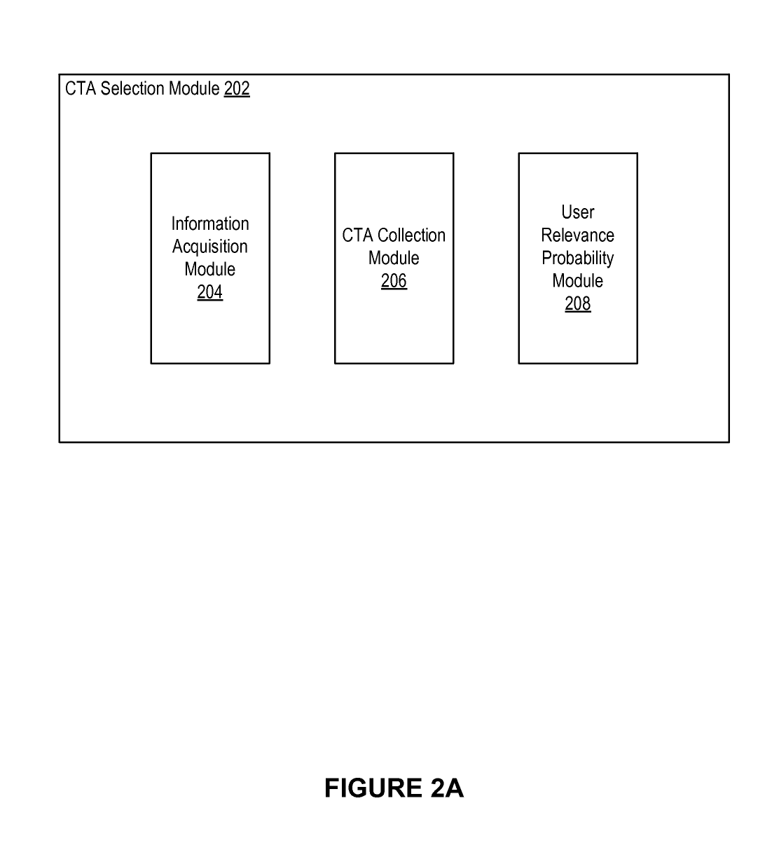

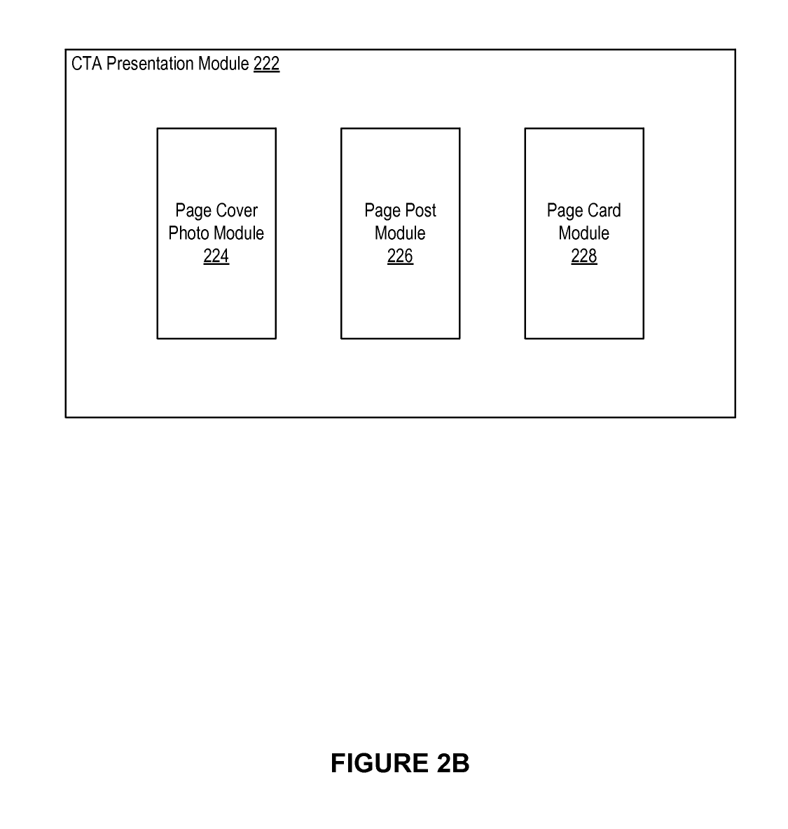

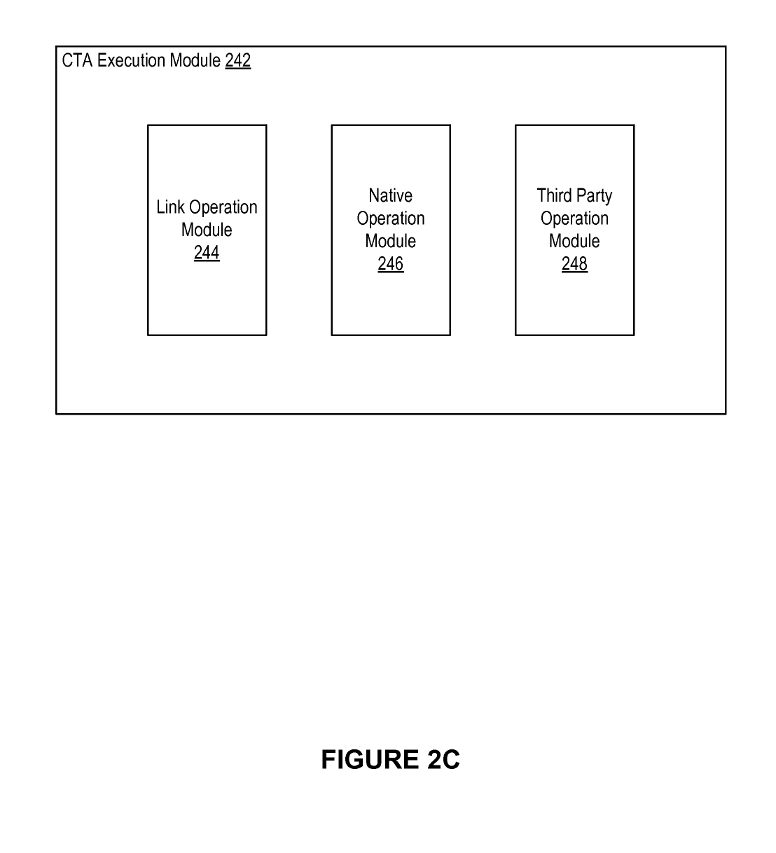

Moreover, the CTA selection module 106 can be configured to facilitate selecting calls to action, such as one or more calls to action for a surface, such as a page, supported by the social networking system. In some implementations, for example, the CTA selection module 106 can facilitate selecting calls to action by acquiring information associated with a user who is accessing the page and selecting at least one call to action, out of a set of calls to action, based at least in part on the information associated with the user. The page can be associated with a page entity and the at least one call to action can be associated with the page entity. The CTA selection module 106 will be described in more detail below with reference to FIG. 2A.

Additionally, the CTA presentation module 108 can be configured to facilitate presenting calls to action, such as the one or more calls to action for a surface, such as a page, supported by the social networking system. For example, the CTA presentation module 108 can facilitate presenting, to the user via the page within the social networking system, the at least one call to action selected by the CTA selection module 106. More details regarding the CTA presentation module 108 will be provided below with reference to FIG. 2B.

Also, the CTA execution module 110 can be configured to facilitate executing calls to action, such as the one or more calls to action for the page within the social networking system. For example, the CTA execution module 110 can facilitate executing one or more actions, tasks, or operations associated with the at least one call to action presented by the CTA presentation module 108. The CTA execution module 110 will be discussed in more detail below with reference to FIG. 2C.

Furthermore, in some embodiments, the social networking CTA module 102 can be configured to communicate and/or operate with the at least one data store 120, as shown in the example system 100. The at least one data store 120 can be configured to store and maintain various types of data. In some implementations, the at least one data store 120 can store information associated with the social networking system (e.g., the social networking system 730 of FIG. 7). The information associated with the social networking system can include data about users, social connections, social interactions, locations, geo-fenced areas, maps, places, events, pages, groups, posts, communications, content, feeds, account settings, privacy settings, a social graph, and various other types of data. In some implementations, the at least one data store 120 can store information associated with users, such as user identifiers, user information, user specified settings, content produced by users, and various other types of user data. In some embodiments, the at least one data store 120 can store information related to calls to action, information related to pages, and/or information related to users, etc., which can be utilized by the social networking CTA module 102. It should be appreciated that there can be many variations and other possibilities.

FIG. 2A illustrates an example call to action (CTA) selection module 202 configured to facilitate selecting calls to action, according to an embodiment of the present disclosure. In some embodiments, the call to action (CTA) selection module 106 of FIG. 1 can be implemented as the call to action (CTA) selection module 202. As shown in FIG. 2A, the call to action (CTA) selection module 202 can include an information acquisition module 204, a call to action (CTA) collection module 206, and a user relevance probability module 208.

In some embodiments, the CTA selection module 202 can utilize the information acquisition module 204 to facilitate acquiring information associated with a user who is accessing (or viewing, visiting, etc.) a surface, such as a page, supported by a social networking system. The information associated with the user can be analyzed and can serve as signals utilized by the CTA selection module 202 to determine which call(s) to action can potentially be relevant, interesting, and/or appropriate for presentation to the user. The CTA selection module 202 can facilitate selecting at least one call to action, out of a set of calls to action, based at least in part on the information associated with the user. As such, the call(s) to action can not only be customized by a page admin of the page, but can also be customized, personalized, or targeted for a user who views or accesses the page.

In some instances, the information associated with the user can include any type of identifying, demographic, status, or similar data regarding the user. Such information can indicate, for example, at least one of an identity of the user, a gender of the user, an age of the user, a location associated with the user, an educational institution associated with the user, a professional institution associated with the user, a language associated with the user, a relationship status of the user, or one or more social connections of the user. For example, the identity of the user can include an identifier (e.g., name, username, user identification number, etc.) for the user within the social networking system. The location associated with the user can, for example, include a residence, a hometown, a locational check-in, or a current geolocation of the user, etc. The educational institution can, for example, include a school, college, or university attended by the user. The professional institution can, for example, include a company or a workplace at which the user has worked, an organization or group of which the user has been a member, etc. For example, the relationship status can indicate whether the user is single, in a relationship, engaged, married, etc. The one or more social connections of the user can correspond to one or more “friends” of the user within the social networking system, for example. There can be many variations.

In some cases, the information associated with the user can include historical data associated with the user. The historical data can be associated with at least one of a browsing history of the user, an application usage history of the user, or a social networking system usage history of the user. The browsing history can, for example, indicate which online resources have been viewed or accessed by the user and for how long. The application usage history of the user can indicate which applications have been installed by the user, which applications have been accessed or utilized by the user, how each application has been accessed or utilized, and for how long. Again, many variations are possible.

In some embodiments, the social networking system usage history of the user can indicate one or more social interactions performed by the user with respect to at least one content item posted via the social networking system. For example, the one or more social interactions can include at least one of an up-vote, a “like”, a comment, a share, or a save.

In some instances, the information associated with the user can indicate that the user is part of a particular defined audience. The social networking system can define custom audiences based on information about users who may share one or more common attributes, historical data, or other considerations. In one example, a particular custom audience can be defined as corresponding to users who have viewed, played, interacted with (e.g., liked), or otherwise accessed a particular content item, such as a video. The selecting of the at least one call to action can be further based at least in part on selection criteria. The selection criteria can provide one or more instructions, rules, and/or policies to govern which call(s) to action is (are) to be selected for particular audiences. The selection criteria can specify that the at least one call to action is to be selected for the particular defined audience of which the user is a part. The selection criteria can specify that if the user is part of the particular custom audience, then when the user visits the page, one or more calls to action that enable the user to conduct a relevant activity can be selected for presentation to the user based on the association of the user with the particular custom audience. Continuing with the example, based on the association of the user with the particular custom audience, one or more calls to action that enable the user to book a ticket for a movie related to the particular video can be selected for presentation to the user via the page. Again, many variations are possible.

Furthermore, in some implementations, the information associated with the user can be dynamically acquired. The information associated with the user can include one or more updates, such as updates about the user's actions or behavior within and/or outside the social networking system. The selecting of the at least one call to action can be performed dynamically based on the one or more updates.

Additionally, in some embodiments, the selecting of the at least one call to action can further comprise determining a respective user relevance probability metric for each call to action in the set of calls to action, determining that one or more calls to action are associated with one or more respective user relevance probability metrics that at least meet a specified user relevance probability threshold, and identifying the at least one call to action to include the one or more calls to action, as described in more detail below.

The CTA collection module 206 can be configured to store, maintain, identify, recognize, or collect, etc., the set of calls to action. The CTA collection module 206 can also store and maintain information about the calls to action within the set. The set of calls to action can include a plurality of calls to action that can potentially be presentable to users who access the page. In some cases, the page or the page entity (e.g., page admin, page representative, etc.) can choose, define, customize, and/or create the calls to action in the set. In some instances, the set can include predefined or default calls to action. In some embodiments, the CTA collection module 206 can correspond to, reside within, communicate with, and/or operate with the at least one data store 120 of FIG. 1.

Furthermore, the user relevance probability module 208 can be configured to facilitate determining, based at least in part on the information associated with the user, a respective user relevance probability metric for each call to action in the set of calls to action. In some cases, the user relevance probability metric for a particular call to action can indicate a likelihood that the particular call will be relevant or interesting to the user who is accessing the page or that the user will choose to execute the particular call to action if presented to the user. In some implementations, the user relevance probability module 208 can communicate or operate with the CTA collection module 206 to access information about the user as well as information about calls to action. Based (at least in part) on such information, the user relevance probability module 208 can determine, calculate, predict, and/or approximate, etc., a respective user relevance probability metric for each call to action in the set. In some cases, the user relevance probability module 208 can determine user relevance probability metrics for the calls to action using (at least in part) one or more machine learning processes. It should be appreciated that there can be many variations and other possibilities.

The user relevance probability module 208 can be further configured to facilitate determining that one or more calls to action are associated with one or more respective user relevance probability metrics that at least meet a specified user relevance probability threshold. A user relevance probability threshold can be selected for the calls to action. In some embodiments, the user relevance probability threshold can be selected by the social networking system or a page entity. For example, the one or more calls to action can be associated with one or more respective user relevance probability metrics (e.g., scores) that each indicate at least a 70% likelihood that its respective call to action will be relevant, interesting, or otherwise appropriate for the user. In this example, the user relevance probability threshold can require at least a 65% likelihood. It should be understood that various thresholds can be suitable. In some cases, the user relevance probability module 208 can utilize (at least in part) one or more machine learning processes to determine, set, or specify the user relevance probability threshold. Again, many variations are possible.

In some embodiments, the CTA selection module 202 can then identify the at least one call to action to include the one or more calls to action associated with the one or more respective user relevance probability metrics that at least meet the specified user relevance probability threshold. When the user relevance probability metrics for the one or more calls to action satisfy the associated user relevance probability threshold(s), the one or more calls to action can be identified and presented. For example, the at least one call to action can then be presented to the user via the page.

Furthermore, in some implementations, the at least one call to action can be selected by the CTA selection module 202 such that the at least one call to action is associated with the page entity. In some cases, the page entity can be a business or brand that corresponds to the page. In some instances, the page entity can be a representative or admin who manages the page on behalf of the business or brand. In one example, the at least one call to action can be associated with the page entity in that the at least one call to action is created or chosen by the page entity. In another example, the at least one call to action can be associated with the page entity in that the at least one call to action leads to an interaction with the page entity (e.g., clicking on the call to action leads to making a purchase with a storefront of the page entity). In a further example, the at least one call to action can be associated with the page entity in that the at least one call to action be associated with a partner (e.g., a business partner, an endorsee, an endorser, a sponsor, etc.) of the page entity. Many variations are possible.

FIG. 2B illustrates an example call to action (CTA) presentation module 222 configured to facilitate presenting calls to action, according to an embodiment of the present disclosure. In some embodiments, the call to action (CTA) presentation module 108 of FIG. 1 can be implemented as the call to action (CTA) presentation module 222. As shown in FIG. 2B, the call to action (CTA) presentation module 222 can include a page cover photo module 224, a page post module 226, and a page card module 228.

As discussed above, the CTA presentation module 222 can facilitate presenting, to the user via a surface, such as a page, supported by the social networking system the at least one call to action selected by the CTA selection module 202 of FIG. 2A. The CTA presentation module 222 of FIG. 2B can, for example, present the at least one call to action by displaying the at least one call to action in association with at least one interactive element, such as at least one button that can be clicked on, tapped on, or otherwise interacted with by the user.

In some embodiments, the CTA presentation module 222 can utilize the page cover photo module 224 to present or display the at least one interactive element within a cover photo of the page. For example, the page can be associated with a particular cover photo. The at least one interactive element (e.g., button) can be displayed as overlaying the particular cover photo.

In some implementations, the CTA presentation module 222 can utilize the page post module 226 to display the at least one interactive element within a post published on the page. For example, the page can present one or more posts of content items that are published by the page entity and/or by one or more users who access the page. The at least one interactive element can be displayed as being attached to, adjacent to, or within the post.

In some implementations, the CTA presentation module 222 can utilize the page card module 228 to display the at least one interactive element within a hover element associated with the page, a search bar element associated with the page, and/or a search result element associated with the page. In one example, when the user performs a mouse hover over a link to the page, the social networking system can present a hover card for the page and the at least one interactive element associated with the call to action can be presented within the hover card. In another example, when the user types characters into a search bar of the social networking system and is presented with potential search results that dynamically include a search bar card for the page, the at least one interactive element can be presented within the search bar card. In a further example, after the user performs a search and is presented with search results that include a search result card for the page, the at least one interactive element can be presented within the search result card.

It is contemplated that many variations are possible. In one example, the at least one interactive element can be displayed as being within an informational section (e.g., an “about” section) of the page. In another example, the CTA presentation module 222 can cause the presenting of the at least one call to action to be performed using at least one of a website configured to communicate with the social networking system (e.g., a website of the social networking system, a website operable with but separate from the social networking system, etc.) or an application configured to communicate with the social networking system (e.g., an application of the social networking system, an application operable with but separate from the social networking system, etc.). In some cases, the application can correspond to a messaging application configured to exchange information and operate with the social networking system and configured to present the at least one call to action in connection with exchanged messages.

FIG. 2C illustrates an example call to action (CTA) execution module 242 configured to facilitate executing calls to action, according to an embodiment of the present disclosure. In some embodiments, the call to action (CTA) execution module 110 of FIG. 1 can be implemented as the call to action (CTA) execution module 242. As shown in FIG. 2C, the call to action (CTA) execution module 242 can include a link action module 244, a native action module 246, and a third party action module 248.

As discussed herein, at least one call to action can be presented via a surface, such as a page, supported by a social networking system to a user who is accessing the page. The CTA execution module 242 can be configured to facilitate detecting a user interaction performed with respect to the at least one call to action. In some instances, the detecting of the user interaction can include determining that a click, a tap, a press, etc., has occurred with respect to an interactive element (e.g., an input element, a button, etc.) associated with the at least one call to action. The CTA execution module 242 can further be configured to facilitate executing an operation associated with the at least one call to action. The operation can correspond to one of a plurality of operations executable for the at least one call to action.

In some implementations, the CTA execution module 242 can be configured to facilitate acquiring one or more instructions from a page entity associated with the page. The operation can be selected out of the plurality of operations by the CTA execution module 242 based at least in part on the one or more instructions from the page entity. In some embodiments, the plurality of operations can include, but is not limited to, at least one of a link navigation operation, a native operation integrated with the social networking system, or a third party operation implemented by a third party operable with the social networking system. Moreover, CTA execution module 242 can cause the operation to be executed in response to the detecting of the user interaction performed with respect to the at least one call to action.

In some instances, when the executed operation corresponds to the link navigation, the link operation module 244 can facilitate the executing of the operation by navigating to a specified link associated with the link navigation operation. For example, when it is detected that a user interaction has been performed with respect to (an interactive button associated with) the at least one call to action, the link operation module 244 can acquire a uniform resource locator (URL) associated with the at least one call to action and cause the uniform resource locator to be opened in a browser, an application, or another service used to access the page.

In some cases, when the executed operation corresponds to the native operation integrated with the social networking system, the native operation module 246 can facilitate the executing of the operation by providing access to at least one of an application or a service integrated with the social networking system. The application or service can provide any type of functionality or content sought by the user. In one example, when the user interaction is detected, the native operation module 246 can open or run a gaming application running at the social networking system. In another example, when the user interaction is detected, the native operation module 246 can navigate to and present a streaming service running at the social networking system, such as a media streaming service associated with the page entity and implemented by the social networking system. As such, a user experience that is more deeply integrated with the social networking system can be provided.

In some embodiments, when the executed operation corresponds to the third party operation implemented by the third party operable with the social networking system, the third party operation module 248 can facilitate the executing of the operation by providing access to at least one of a third party application or a third party service. Any type of third party application or third party service can be implemented. For instance, when the user interaction is detected, the third party operation module 248 can navigate to and present a ride-sharing application implemented, developed, managed, or otherwise utilized by the third party (e.g., the page entity, an entity or partner associated with the page entity, an entity separate from the page entity, etc.). In another example, when the user interaction is detected, the third party operation module 248 can provide, such as via the page within the social networking system, a shopping service. In this example, the shopping service can correspond to an e-commerce storefront implemented, developed, managed, or otherwise utilized by the third party but accessible from the page within the social networking system. As such, a user experience that is more customized, such as by the third party, can be provided.

In some embodiments, information associated with the user can be acquired. In one example, based at least in part on at least a portion of the information associated with the user, the CTA execution module 242 can select the operation out of the plurality of operations. In another example, the CTA execution module 242 can utilize at least a portion of the information associated with the user in the executing of the operation, such as by pre-filling or pre-populating a form with at least the portion of the information during the executing of the operation. The form can, for example, correspond to a lead generation form that takes user information as input. In a further example, the CTA execution module 242 can utilize locational (e.g., GPS) information associated with the user in the executing of the operation by running a ride-sharing application (or service) and providing the user's locational information to the ride-sharing application. Many variations are possible.

In some cases, an identifier of the user can be acquired. Based on an expression of consent by the user, the CTA execution module 242 can sign the user, based at least in part on the identifier, into account(s) of the user with one or more applications or services associated with the at least one call to action. For example, since the user has already been authenticated and signed (or logged) into the social networking system, the user can be automatically signed into his or her user account with the application or the service. The authentications automatically performed by the CTA execution module 242 can obviate the burden on the user of otherwise having to manually sign into every account of the user with an application(s) or service(s) that participates in the execution of a call to action. Furthermore, in some implementations, information associated with the account of the user can be provided to the user via the page. In one example, if the user has so consented, subsequent to signing into the social networking system, the disclosed technology can automatically sign the user into an airline account of his or hers. In this example, the user can automatically be presented with his or her airline information, including frequent flyer points/miles or travel itineraries, via the page within the social networking system. In another example, the disclosed technology can automatically sign the user into an e-commerce account of his or hers. The user can, in this example, automatically be presented with his or her e-commerce information, including order details or shipping/tracking information, via the page within the social networking system. Again, it is contemplated that many variations are possible.

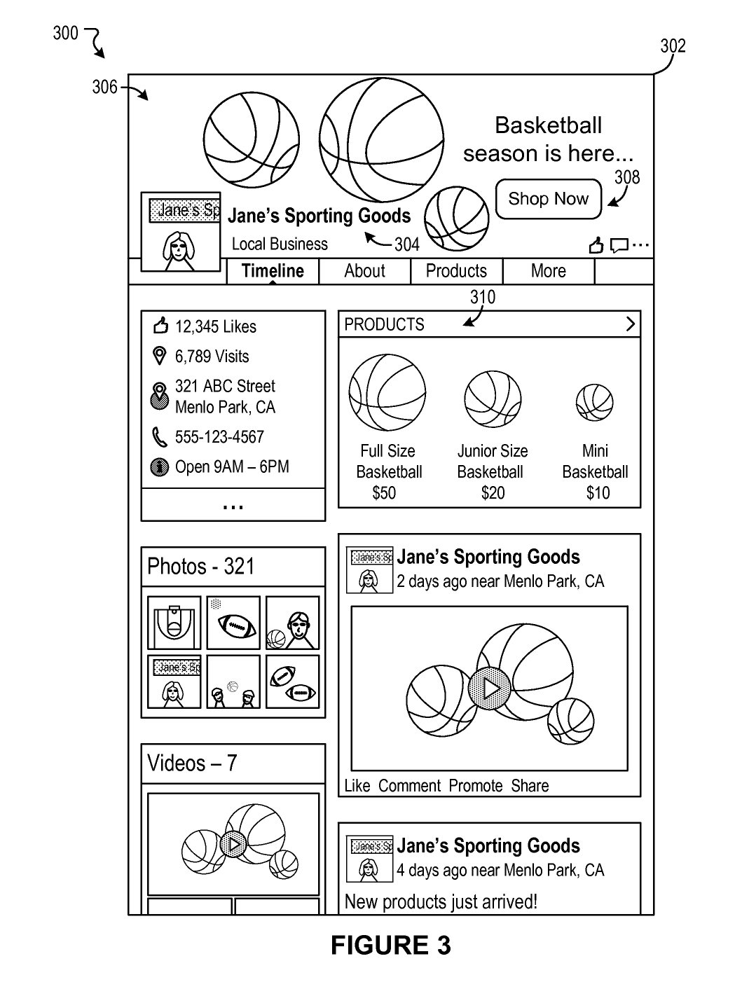

FIG. 3 illustrates an example scenario 300 associated with utilizing calls to action, according to an embodiment of the present disclosure. The example scenario 300 illustrates an example page 302 within a social networking system (e.g., the social networking system 730 of FIG. 7). The page 302 can be associated with an example page entity 304. In the example scenario 300, the page entity 304 can correspond to a local business, Jane's Sporting Goods. Moreover, the page 302 can be managed by a page admin, a page “owner,” and/or a representative of the local business, for example, Jane Doe.

As shown in FIG. 3, the page 302 can include a cover photo 306. In this example scenario 300, the disclosed technology can present a call to action 308 within the cover photo 306, such as by overlaying the call to action 308 on top of the cover photo 306. The call to action 308 can include or can be associated with an interactive element, such as a button. When a user who is accessing or viewing the page 302 clicks on, taps on, or otherwise interacts with the call to action 308 (i.e., interacts with the interactive element associated with the call to action 308), the disclosed technology can execute an operation associated with the call to action 308, as discussed above.

Moreover, in this example scenario 300, the page entity 304 (or the page admin, the page “owner,” the representative, etc.) can customize the call to action 308 to correspond to “Shop Now.” Additionally, this particular call to action 308 can be targeted for the particular user. The particular call to action 308 can be selected for presentation based on information about the particular user who is accessing or viewing the page 302. In this example scenario 300, the disclosed technology can have determined or predicted, based on (at least a portion of) information associated with the user, that the user would likely be interested in shopping for products related to sports (e.g., basketball).

Furthermore, in this example, when it is detected that the user has interacted with or activated the call to action “Shop Now” 308 (i.e., interacted with or activated the interactive element associated with the call to action 308), the disclosed technology can execute the operation associated with the call to action 308. The operation can, for example, correspond to navigating to and/or opening a shopping service, such as an e-commerce storefront 310, provided via the page 302. As such, the user can more easily or more conveniently shop for basketball products. Again, it should be understood that this example scenario 300 is provided for illustrative purposes and that there can be many variations and other possibilities.

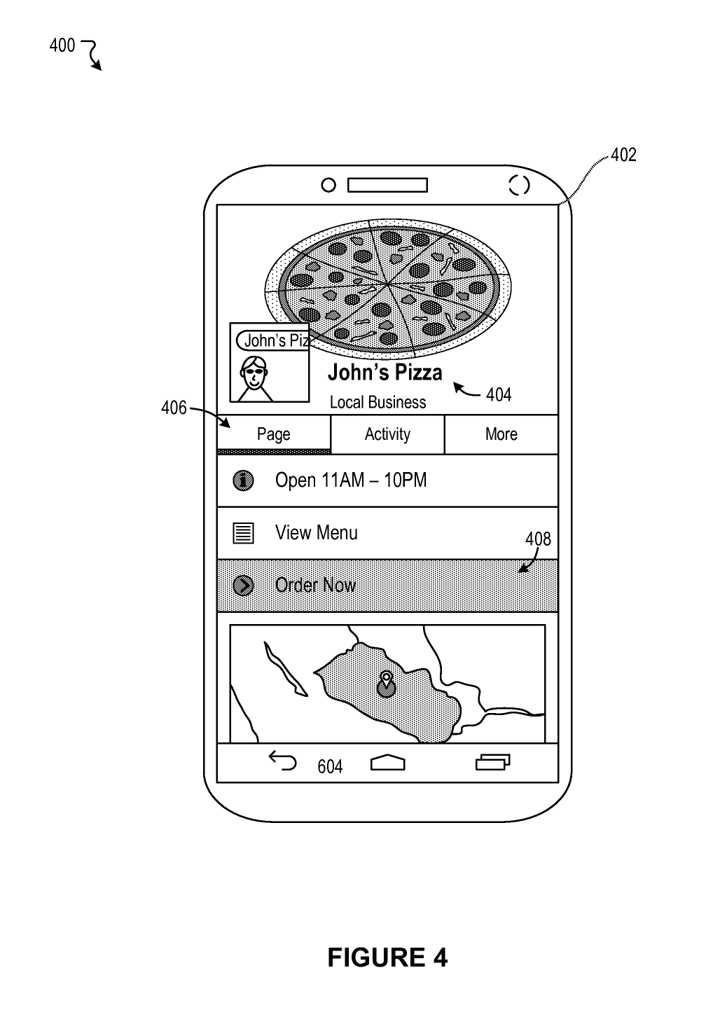

FIG. 4 illustrates an example scenario 400 associated with utilizing calls to action, according to an embodiment of the present disclosure. The example scenario 400 illustrates an example page 402 within a social networking system (e.g., the social networking system 730 of FIG. 7). The example page 402 can be presented at a computing device (or system), such as a smartphone or tablet computer. The page 402 can be associated with an example page entity 404. In the example scenario 400, the page entity 404 can correspond to a local business, John's Pizza. Moreover, the page 402 can be managed by a page admin, a page “owner,” and/or a representative of the local business, for example, John Doe.

As shown in FIG. 4, the page 402 can include an informational section 406. In this example scenario 400, the disclosed technology can present a call to action “Order Now” 408 within the informational section 406 of the page 402. When a user who is accessing or viewing the page 402 clicks on, taps on, or otherwise interacts with the call to action 408 (i.e., interacts with an interactive element associated with the call to action 408), the disclosed technology can execute an operation associated with the call to action 408, as discussed above. In this example, the operation can be associated with ordering pizza at Joe's Pizza.

In some instances, various embodiments of the present disclosure can be provided or utilized independent of platform (e.g., desktop website, desktop application, mobile website, mobile application, operating system, etc.). In some cases, various embodiments of the present disclosure can be customized or modified for each platform. Many variations are possible.

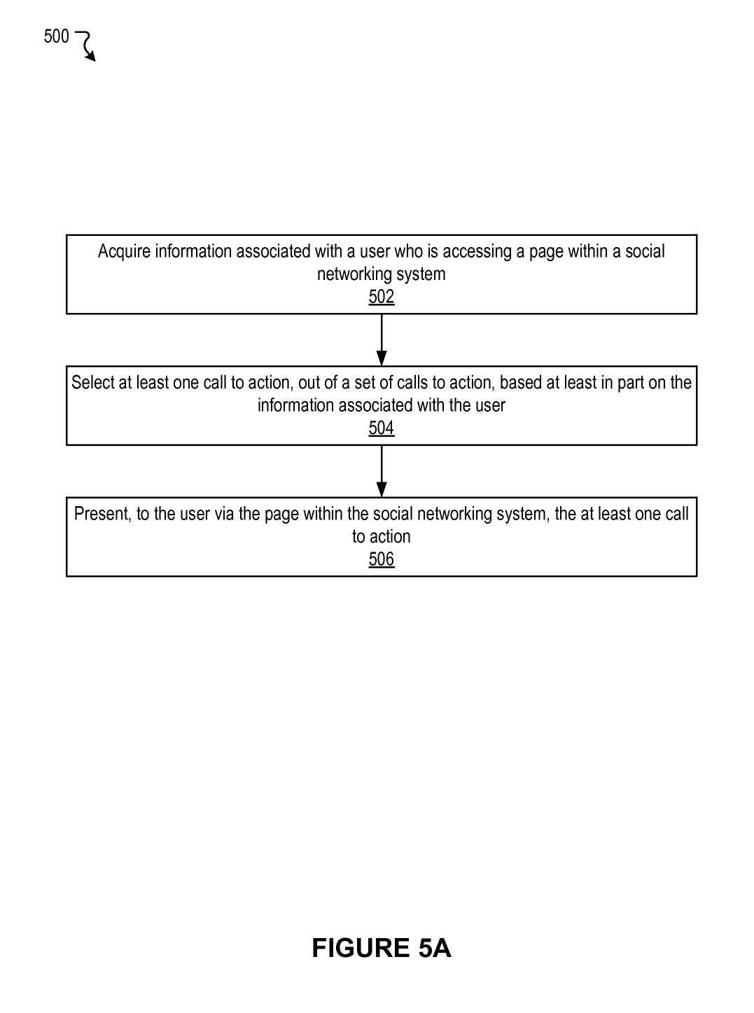

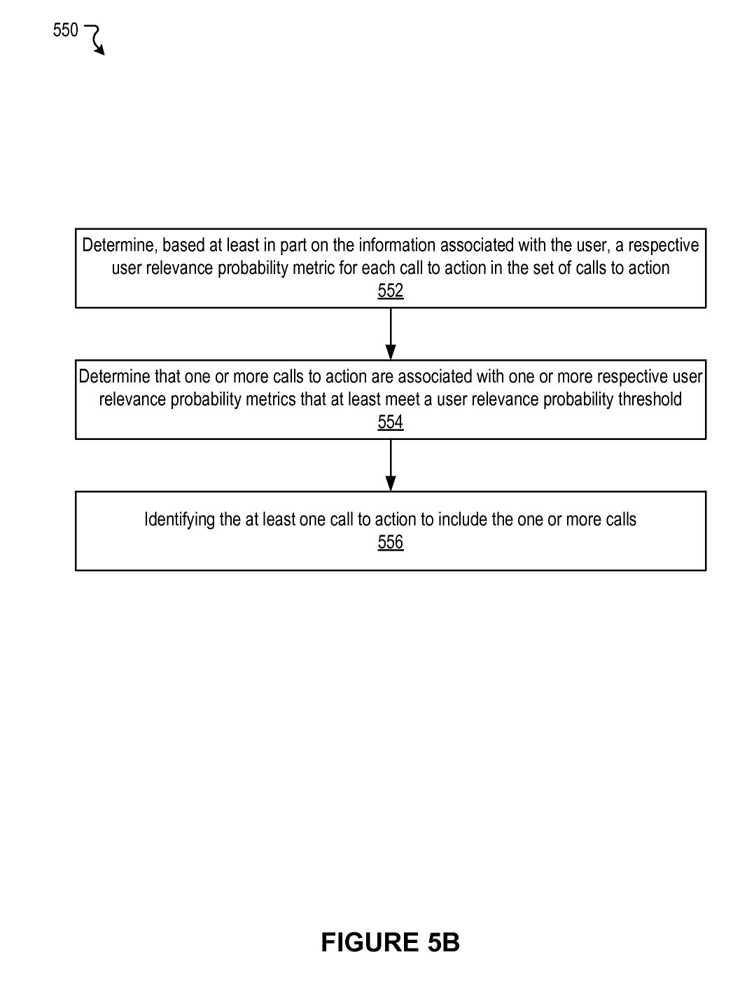

FIG. 5A illustrates an example method 500 associated with utilizing calls to action, according to an embodiment of the present disclosure. It should be appreciated that there can be additional, fewer, or alternative steps performed in similar or alternative orders, or in parallel, within the scope of the various embodiments unless otherwise stated.

At block 502, the example method 500 can acquire information associated with a user who is accessing a page within a social networking system. The page can be associated with a page entity. At block 504, the example method 500 can select at least one call to action, out of a set of calls to action, based at least in part on the information associated with the user. The at least one call to action can be associated with the page entity. At block 506, the example method 500 can present, to the user via the page within the social networking system, the at least one call to action.

FIG. 5B illustrates an example method 550 associated with utilizing calls to action, according to an embodiment of the present disclosure. Again, it should be appreciated that there can be additional, fewer, or alternative steps performed in similar or alternative orders, or in parallel, within the scope of the various embodiments unless otherwise stated.

At block 552, the example method 550 can determine, based at least in part on the information associated with the user, a respective user relevance probability metric for each call to action in the set of calls to action. At block 554, the example method 550 can determine that one or more calls to action are associated with one or more respective user relevance probability metrics that at least meet a specified user relevance probability threshold. At block 556, the example method 550 can identify the at least one call to action to include the one or more calls to action associated with the one or more respective user relevance probability metrics that at least meet the specified user relevance probability threshold.

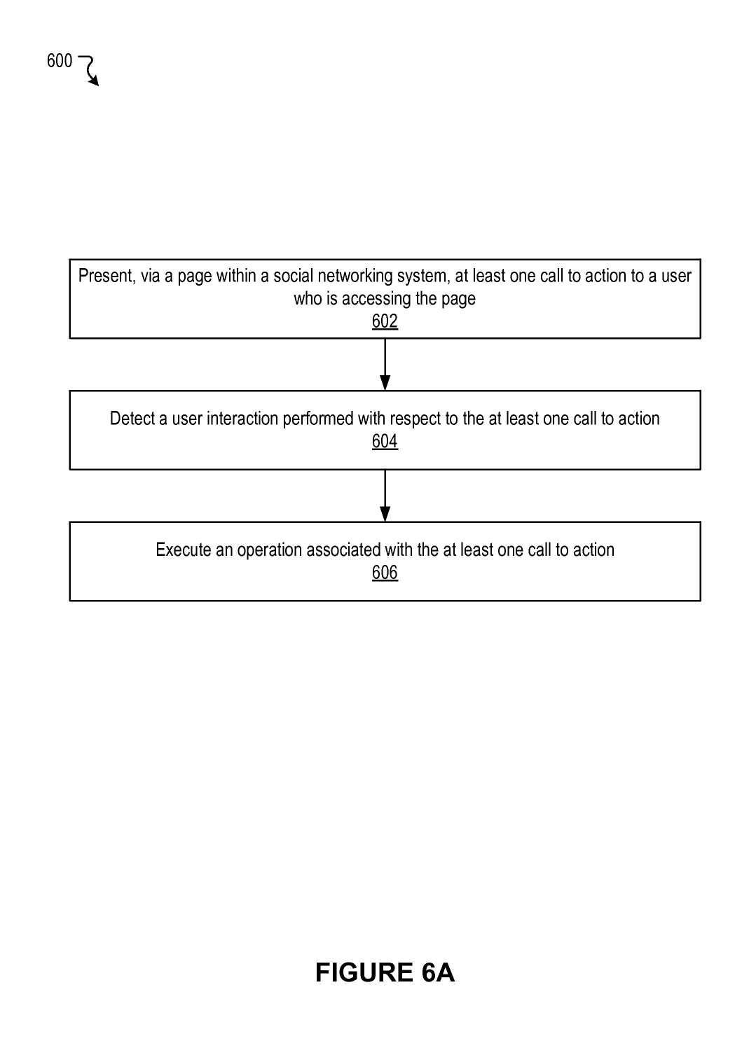

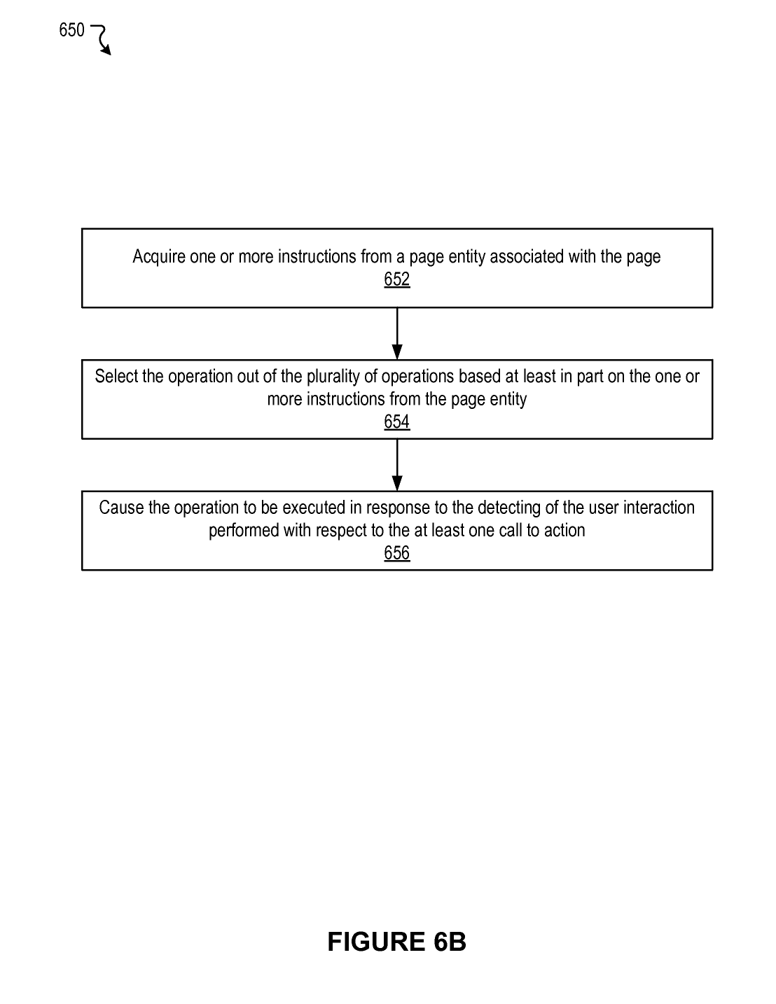

FIG. 6A illustrates an example method 600 associated with utilizing calls to action, according to an embodiment of the present disclosure. As discussed above, it should be understood that there can be additional, fewer, or alternative steps performed in similar or alternative orders, or in parallel, within the scope of the various embodiments unless otherwise stated.

At block 602, the example method 600 can present, via a page within a social networking system, at least one call to action to a user who is accessing the page. At block 604, the example method 600 can detect a user interaction performed with respect to the at least one call to action. At block 606, the example method 600 can execute an operation associated with the at least one call to action. The operation can correspond to one of a plurality of operations executable for the at least one call to action.

FIG. 6B illustrates an example method 650 associated with utilizing calls to action, according to an embodiment of the present disclosure. Again, it should be understood that there can be additional, fewer, or alternative steps performed in similar or alternative orders, or in parallel, within the scope of the various embodiments unless otherwise stated.

At block 652, the example method 650 can acquire one or more instructions from a page entity associated with the page. At block 654, the example method 650 can select the operation out of the plurality of operations based at least in part on the one or more instructions from the page entity. At block 656, the example method 650 can cause the operation to be executed in response to the detecting of the user interaction performed with respect to the at least one call to action.

In some embodiments, the page (or content on the page) can be represented as a first node in a social graph associated with the social network system and the user can be represented as a second node in the social graph. When the user interacts with the at least one call to action presented via the page, an edge can be created between the first and second nodes in the social graph.

It is contemplated that there can be many other uses, applications, and/or variations associated with the various embodiments of the present disclosure. For example, in some cases, user can choose whether or not to opt-in to utilize the disclosed technology. The disclosed technology can also ensure that various privacy settings and preferences are maintained and can prevent private information from being divulged. In another example, various embodiments of the present disclosure can learn, improve, and/or be refined over time.

### Social Networking System—Example Implementation

FIG. 7 illustrates a network diagram of an example system 700 that can be utilized in various scenarios, in accordance with an embodiment of the present disclosure. The system 700 includes one or more user devices 710, one or more external systems 720, a social networking system (or service) 730, and a network 750. In an embodiment, the social networking service, provider, and/or system discussed in connection with the embodiments described above may be implemented as the social networking system 730. For purposes of illustration, the embodiment of the system 700, shown by FIG. 7, includes a single external system 720 and a single user device 710. However, in other embodiments, the system 700 may include more user devices 710 and/or more external systems 720. In certain embodiments, the social networking system 730 is operated by a social network provider, whereas the external systems 720 are separate from the social networking system 730 in that they may be operated by different entities. In various embodiments, however, the social networking system 730 and the external systems 720 operate in conjunction to provide social networking services to users (or members) of the social networking system 730. In this sense, the social networking system 730 provides a platform or backbone, which other systems, such as external systems 720, may use to provide social networking services and functionalities to users across the Internet.

The user device 710 comprises one or more computing devices (or systems) that can receive input from a user and transmit and receive data via the network 750. In one embodiment, the user device 710 is a conventional computer system executing, for example, a Microsoft Windows compatible operating system (OS), Apple OS X, and/or a Linux distribution. In another embodiment, the user device 710 can be a computing device or a device having computer functionality, such as a smartphone, a tablet, a personal digital assistant (PDA), a mobile telephone, a laptop computer, a wearable device (e.g., a pair of glasses, a watch, a bracelet, etc.), a camera, an appliance, etc. The user device 710 is configured to communicate via the network 750. The user device 710 can execute an application, for example, a browser application that allows a user of the user device 710 to interact with the social networking system 730. In another embodiment, the user device 710 interacts with the social networking system 730 through an application programming interface (API) provided by the native operating system of the user device 710, such as iOS and ANDROID. The user device 710 is configured to communicate with the external system 720 and the social networking system 730 via the network 750, which may comprise any combination of local area and/or wide area networks, using wired and/or wireless communication systems.

In one embodiment, the network 750 uses standard communications technologies and protocols. Thus, the network 750 can include links using technologies such as Ethernet, 702.11, worldwide interoperability for microwave access (WiMAX), 3G, 4G, CDMA, GSM, LTE, digital subscriber line (DSL), etc. Similarly, the networking protocols used on the network 750 can include multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over the network 750 can be represented using technologies and/or formats including hypertext markup language (HTML) and extensible markup language (XML). In addition, all or some links can be encrypted using conventional encryption technologies such as secure sockets layer (SSL), transport layer security (TLS), and Internet Protocol security (IPsec).

In one embodiment, the user device 710 may display content from the external system 720 and/or from the social networking system 730 by processing a markup language document 714 received from the external system 720 and from the social networking system 730 using a browser application 712. The markup language document 714 identifies content and one or more instructions describing formatting or presentation of the content. By executing the instructions included in the markup language document 714, the browser application 712 displays the identified content using the format or presentation described by the markup language document 714. For example, the markup language document 714 includes instructions for generating and displaying a web page having multiple frames that include text and/or image data retrieved from the external system 720 and the social networking system 730. In various embodiments, the markup language document 714 comprises a data file including extensible markup language (XML) data, extensible hypertext markup language (XHTML) data, or other markup language data. Additionally, the markup language document 714 may include JavaScript Object Notation (JSON) data, JSON with padding (JSONP), and JavaScript data to facilitate data-interchange between the external system 720 and the user device 710. The browser application 712 on the user device 710 may use a JavaScript compiler to decode the markup language document 714.

The markup language document 714 may also include, or link to, applications or application frameworks such as FLASH™ or Unity™ applications, the SilverLight™ application framework, etc.

In one embodiment, the user device 710 also includes one or more cookies 716 including data indicating whether a user of the user device 710 is logged into the social networking system 730, which may enable modification of the data communicated from the social networking system 730 to the user device 710.

The external system 720 includes one or more web servers that include one or more web pages 722a, 722b, which are communicated to the user device 710 using the network 750. The external system 720 is separate from the social networking system 730. For example, the external system 720 is associated with a first domain, while the social networking system 730 is associated with a separate social networking domain. Web pages 722a, 722b, included in the external system 720, comprise markup language documents 714 identifying content and including instructions specifying formatting or presentation of the identified content.

The social networking system 730 includes one or more computing devices for a social network, including a plurality of users, and providing users of the social network with the ability to communicate and interact with other users of the social network. In some instances, the social network can be represented by a graph, i.e., a data structure including edges and nodes. Other data structures can also be used to represent the social network, including but not limited to databases, objects, classes, meta elements, files, or any other data structure. The social networking system 730 may be administered, managed, or controlled by an operator. The operator of the social networking system 730 may be a human being, an automated application, or a series of applications for managing content, regulating policies, and collecting usage metrics within the social networking system 730. Any type of operator may be used.

Users may join the social networking system 730 and then add connections to any number of other users of the social networking system 730 to whom they desire to be connected. As used herein, the term “friend” refers to any other user of the social networking system 730 to whom a user has formed a connection, association, or relationship via the social networking system 730. For example, in an embodiment, if users in the social networking system 730 are represented as nodes in the social graph, the term “friend” can refer to an edge formed between and directly connecting two user nodes.

Connections may be added explicitly by a user or may be automatically created by the social networking system 730 based on common characteristics of the users (e.g., users who are alumni of the same educational institution). For example, a first user specifically selects a particular other user to be a friend. Connections in the social networking system 730 are usually in both directions, but need not be, so the terms “user” and “friend” depend on the frame of reference. Connections between users of the social networking system 730 are usually bilateral (“two-way”), or “mutual,” but connections may also be unilateral, or “one-way.” For example, if Bob and Joe are both users of the social networking system 730 and connected to each other, Bob and Joe are each other's connections. If, on the other hand, Bob wishes to connect to Joe to view data communicated to the social networking system 730 by Joe, but Joe does not wish to form a mutual connection, a unilateral connection may be established. The connection between users may be a direct connection; however, some embodiments of the social networking system 730 allow the connection to be indirect via one or more levels of connections or degrees of separation.

In addition to establishing and maintaining connections between users and allowing interactions between users, the social networking system 730 provides users with the ability to take actions on various types of items supported by the social networking system 730. These items may include groups or networks (i.e., social networks of people, entities, and concepts) to which users of the social networking system 730 may belong, events or calendar entries in which a user might be interested, computer-based applications that a user may use via the social networking system 730, transactions that allow users to buy or sell items via services provided by or through the social networking system 730, and interactions with advertisements that a user may perform on or off the social networking system 730. These are just a few examples of the items upon which a user may act on the social networking system 730, and many others are possible. A user may interact with anything that is capable of being represented in the social networking system 730 or in the external system 720, separate from the social networking system 730, or coupled to the social networking system 730 via the network 750.

The social networking system 730 is also capable of linking a variety of entities. For example, the social networking system 730 enables users to interact with each other as well as external systems 720 or other entities through an API, a web service, or other communication channels. The social networking system 730 generates and maintains the “social graph” comprising a plurality of nodes interconnected by a plurality of edges. Each node in the social graph may represent an entity that can act on another node and/or that can be acted on by another node. The social graph may include various types of nodes. Examples of types of nodes include users, non-person entities, content items, web pages, groups, activities, messages, concepts, and any other things that can be represented by an object in the social networking system 730. An edge between two nodes in the social graph may represent a particular kind of connection, or association, between the two nodes, which may result from node relationships or from an action that was performed by one of the nodes on the other node. In some cases, the edges between nodes can be weighted. The weight of an edge can represent an attribute associated with the edge, such as a strength of the connection or association between nodes. Different types of edges can be provided with different weights. For example, an edge created when one user “likes” another user may be given one weight, while an edge created when a user befriends another user may be given a different weight.

As an example, when a first user identifies a second user as a friend, an edge in the social graph is generated connecting a node representing the first user and a second node representing the second user. As various nodes relate or interact with each other, the social networking system 730 modifies edges connecting the various nodes to reflect the relationships and interactions.

The social networking system 730 also includes user-generated content, which enhances a user's interactions with the social networking system 730. User-generated content may include anything a user can add, upload, send, or “post” to the social networking system 730. For example, a user communicates posts to the social networking system 730 from a user device 710. Posts may include data such as status updates or other textual data, location information, images such as photos, videos, links, music or other similar data and/or media. Content may also be added to the social networking system 730 by a third party. Content “items” are represented as objects in the social networking system 730. In this way, users of the social networking system 730 are encouraged to communicate with each other by posting text and content items of various types of media through various communication channels. Such communication increases the interaction of users with each other and increases the frequency with which users interact with the social networking system 730.

The social networking system 730 includes a web server 732, an API request server 734, a user profile store 736, a connection store 738, an action logger 740, an activity log 742, and an authorization server 744. In an embodiment of the invention, the social networking system 730 may include additional, fewer, or different components for various applications. Other components, such as network interfaces, security mechanisms, load balancers, failover servers, management and network operations consoles, and the like are not shown so as to not obscure the details of the system.

The user profile store 736 maintains information about user accounts, including biographic, demographic, and other types of descriptive information, such as work experience, educational history, hobbies or preferences, location, and the like that has been declared by users or inferred by the social networking system 730. This information is stored in the user profile store 736 such that each user is uniquely identified. The social networking system 730 also stores data describing one or more connections between different users in the connection store 738. The connection information may indicate users who have similar or common work experience, group memberships, hobbies, or educational history. Additionally, the social networking system 730 includes user-defined connections between different users, allowing users to specify their relationships with other users. For example, user-defined connections allow users to generate relationships with other users that parallel the users' real-life relationships, such as friends, co-workers, partners, and so forth. Users may select from predefined types of connections, or define their own connection types as needed. Connections with other nodes in the social networking system 730, such as non-person entities, buckets, cluster centers, images, interests, pages, external systems, concepts, and the like are also stored in the connection store 738.

The social networking system 730 maintains data about objects with which a user may interact. To maintain this data, the user profile store 736 and the connection store 738 store instances of the corresponding type of objects maintained by the social networking system 730. Each object type has information fields that are suitable for storing information appropriate to the type of object. For example, the user profile store 736 contains data structures with fields suitable for describing a user's account and information related to a user's account. When a new object of a particular type is created, the social networking system 730 initializes a new data structure of the corresponding type, assigns a unique object identifier to it, and begins to add data to the object as needed. This might occur, for example, when a user becomes a user of the social networking system 730, the social networking system 730 generates a new instance of a user profile in the user profile store 736, assigns a unique identifier to the user account, and begins to populate the fields of the user account with information provided by the user.

The connection store 738 includes data structures suitable for describing a user's connections to other users, connections to external systems 720 or connections to other entities. The connection store 738 may also associate a connection type with a user's connections, which may be used in conjunction with the user's privacy setting to regulate access to information about the user. In an embodiment of the invention, the user profile store 736 and the connection store 738 may be implemented as a federated database.

Data stored in the connection store 738, the user profile store 736, and the activity log 742 enables the social networking system 730 to generate the social graph that uses nodes to identify various objects and edges connecting nodes to identify relationships between different objects. For example, if a first user establishes a connection with a second user in the social networking system 730, user accounts of the first user and the second user from the user profile store 736 may act as nodes in the social graph. The connection between the first user and the second user stored by the connection store 738 is an edge between the nodes associated with the first user and the second user. Continuing this example, the second user may then send the first user a message within the social networking system 730. The action of sending the message, which may be stored, is another edge between the two nodes in the social graph representing the first user and the second user. Additionally, the message itself may be identified and included in the social graph as another node connected to the nodes representing the first user and the second user.

In another example, a first user may tag a second user in an image that is maintained by the social networking system 730 (or, alternatively, in an image maintained by another system outside of the social networking system 730). The image may itself be represented as a node in the social networking system 730. This tagging action may create edges between the first user and the second user as well as create an edge between each of the users and the image, which is also a node in the social graph. In yet another example, if a user confirms attending an event, the user and the event are nodes obtained from the user profile store 736, where the attendance of the event is an edge between the nodes that may be retrieved from the activity log 742. By generating and maintaining the social graph, the social networking system 730 includes data describing many different types of objects and the interactions and connections among those objects, providing a rich source of socially relevant information.

The web server 732 links the social networking system 730 to one or more user devices 710 and/or one or more external systems 720 via the network 750. The web server 732 serves web pages, as well as other web-related content, such as Java, JavaScript, Flash, XML, and so forth. The web server 732 may include a mail server or other messaging functionality for receiving and routing messages between the social networking system 730 and one or more user devices 710. The messages can be instant messages, queued messages (e.g., email), text and SMS messages, or any other suitable messaging format.

The API request server 734 allows one or more external systems 720 and user devices 710 to call access information from the social networking system 730 by calling one or more API functions. The API request server 734 may also allow external systems 720 to send information to the social networking system 730 by calling APIs. The external system 720, in one embodiment, sends an API request to the social networking system 730 via the network 750, and the API request server 734 receives the API request. The API request server 734 processes the request by calling an API associated with the API request to generate an appropriate response, which the API request server 734 communicates to the external system 720 via the network 750. For example, responsive to an API request, the API request server 734 collects data associated with a user, such as the user's connections that have logged into the external system 720, and communicates the collected data to the external system 720. In another embodiment, the user device 710 communicates with the social networking system 730 via APIs in the same manner as external systems 720.

The action logger 740 is capable of receiving communications from the web server 732 about user actions on and/or off the social networking system 730. The action logger 740 populates the activity log 742 with information about user actions, enabling the social networking system 730 to discover various actions taken by its users within the social networking system 730 and outside of the social networking system 730. Any action that a particular user takes with respect to another node on the social networking system 730 may be associated with each user's account, through information maintained in the activity log 742 or in a similar database or other data repository. Examples of actions taken by a user within the social networking system 730 that are identified and stored may include, for example, adding a connection to another user, sending a message to another user, reading a message from another user, viewing content associated with another user, attending an event posted by another user, posting an image, attempting to post an image, or other actions interacting with another user or another object. When a user takes an action within the social networking system 730, the action is recorded in the activity log 742. In one embodiment, the social networking system 730 maintains the activity log 742 as a database of entries. When an action is taken within the social networking system 730, an entry for the action is added to the activity log 742. The activity log 742 may be referred to as an action log.

Additionally, user actions may be associated with concepts and actions that occur within an entity outside of the social networking system 730, such as an external system 720 that is separate from the social networking system 730. For example, the action logger 740 may receive data describing a user's interaction with an external system 720 from the web server 732. In this example, the external system 720 reports a user's interaction according to structured actions and objects in the social graph.

Other examples of actions where a user interacts with an external system 720 include a user expressing an interest in an external system 720 or another entity, a user posting a comment to the social networking system 730 that discusses an external system 720 or a web page 722a within the external system 720, a user posting to the social networking system 730 a Uniform Resource Locator (URL) or other identifier associated with an external system 720, a user attending an event associated with an external system 720, or any other action by a user that is related to an external system 720. Thus, the activity log 742 may include actions describing interactions between a user of the social networking system 730 and an external system 720 that is separate from the social networking system 730.

The authorization server 744 enforces one or more privacy settings of the users of the social networking system 730. A privacy setting of a user determines how particular information associated with a user can be shared. The privacy setting comprises the specification of particular information associated with a user and the specification of the entity or entities with whom the information can be shared. Examples of entities with which information can be shared may include other users, applications, external systems 720, or any entity that can potentially access the information. The information that can be shared by a user comprises user account information, such as profile photos, phone numbers associated with the user, user's connections, actions taken by the user such as adding a connection, changing user profile information, and the like.

The privacy setting specification may be provided at different levels of granularity. For example, the privacy setting may identify specific information to be shared with other users; the privacy setting identifies a work phone number or a specific set of related information, such as, personal information including profile photo, home phone number, and status. Alternatively, the privacy setting may apply to all the information associated with the user. The specification of the set of entities that can access particular information can also be specified at various levels of granularity. Various sets of entities with which information can be shared may include, for example, all friends of the user, all friends of friends, all applications, or all external systems 720. One embodiment allows the specification of the set of entities to comprise an enumeration of entities. For example, the user may provide a list of external systems 720 that are allowed to access certain information. Another embodiment allows the specification to comprise a set of entities along with exceptions that are not allowed to access the information. For example, a user may allow all external systems 720 to access the user's work information, but specify a list of external systems 720 that are not allowed to access the work information. Certain embodiments call the list of exceptions that are not allowed to access certain information a “block list”. External systems 720 belonging to a block list specified by a user are blocked from accessing the information specified in the privacy setting. Various combinations of granularity of specification of information, and granularity of specification of entities, with which information is shared are possible. For example, all personal information may be shared with friends whereas all work information may be shared with friends of friends.

The authorization server 744 contains logic to determine if certain information associated with a user can be accessed by a user's friends, external systems 720, and/or other applications and entities. The external system 720 may need authorization from the authorization server 744 to access the user's more private and sensitive information, such as the user's work phone number. Based on the user's privacy settings, the authorization server 744 determines if another user, the external system 720, an application, or another entity is allowed to access information associated with the user, including information about actions taken by the user.

In some embodiments, the social networking system 730 can include a social networking CTA module 746. The social networking CTA module 746 can, for example, be implemented as the social networking CTA module 102 of FIG. 1. In some implementations, the social networking CTA module 746 can be configured to facilitate acquiring information associated with a user who is accessing a page within a social networking system. The page can be associated with a page entity. The social networking CTA module 746 can also be configured to facilitate selecting at least one call to action, out of a set of calls to action, based at least in part on the information associated with the user. The at least one call to action can be associated with the page entity. Moreover, the social networking CTA module 746 can further be configured to facilitate presenting, to the user via the page within the social networking system, the at least one call to action. Additionally, in some embodiments, the social networking CTA module 746 can be configured to facilitate detecting a user interaction performed with respect to the at least one call to action. Furthermore, the social networking CTA module 746 can be configured to facilitate executing an operation associated with the at least one call to action. The operation can correspond to one of a plurality of operations executable for the at least one call to action. As discussed previously, it should be appreciated that there can be many variations and other possibilities. Other features of the social networking CTA module 746 are discussed herein in connection with the social networking CTA module 102.

### Hardware Implementation

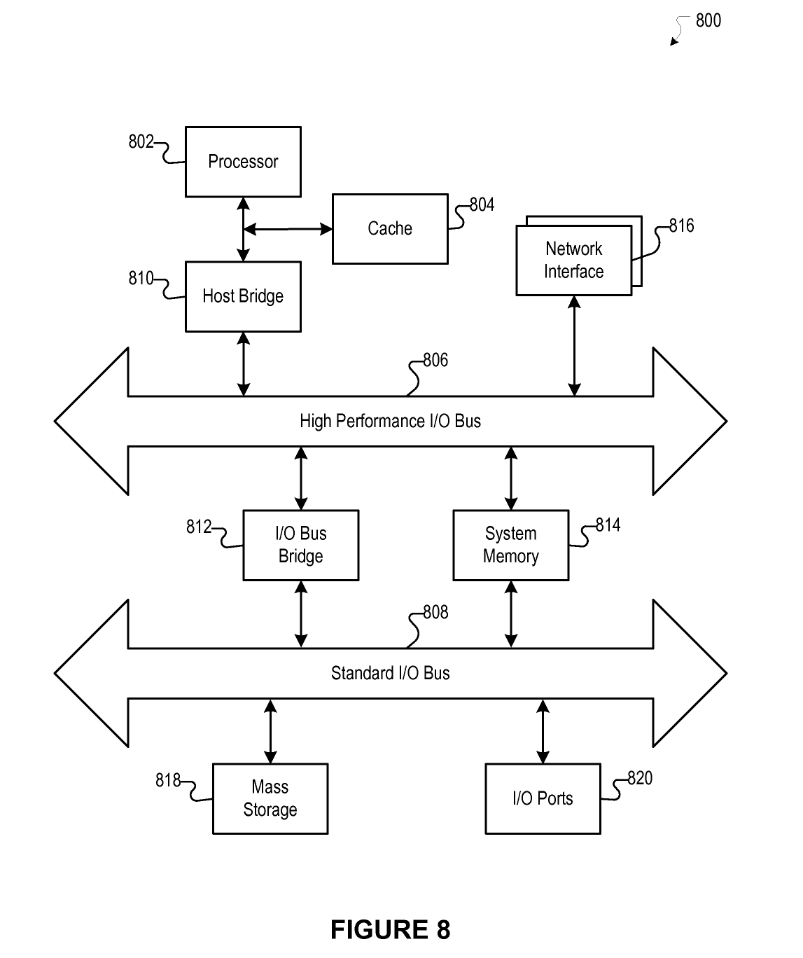

The foregoing processes and features can be implemented by a wide variety of machine and computer system architectures and in a wide variety of network and computing environments. FIG. 8 illustrates an example of a computer system 800 that may be used to implement one or more of the embodiments described herein in accordance with an embodiment of the invention. The computer system 800 includes sets of instructions for causing the computer system 800 to perform the processes and features discussed herein. The computer system 800 may be connected (e.g., networked) to other machines. In a networked deployment, the computer system 800 may operate in the capacity of a server machine or a client machine in a client-server network environment, or as a peer machine in a peer-to-peer (or distributed) network environment. In an embodiment of the invention, the computer system 800 may be the social networking system 730, the user device 710, and the external system 820, or a component thereof. In an embodiment of the invention, the computer system 800 may be one server among many that constitutes all or part of the social networking system 730.

The computer system 800 includes a processor 802, a cache 804, and one or more executable modules and drivers, stored on a computer-readable medium, directed to the processes and features described herein. Additionally, the computer system 800 includes a high performance input/output (I/O) bus 806 and a standard I/O bus 808. A host bridge 810 couples processor 802 to high performance I/O bus 806, whereas I/O bus bridge 812 couples the two buses 806 and 808 to each other. A system memory 814 and one or more network interfaces 816 couple to high performance I/O bus 806. The computer system 800 may further include video memory and a display device coupled to the video memory (not shown). Mass storage 818 and I/O ports 820 couple to the standard I/O bus 808. The computer system 800 may optionally include a keyboard and pointing device, a display device, or other input/output devices (not shown) coupled to the standard I/O bus 808. Collectively, these elements are intended to represent a broad category of computer hardware systems, including but not limited to computer systems based on the x86-compatible processors manufactured by Intel Corporation of Santa Clara, Calif., and the x86-compatible processors manufactured by Advanced Micro Devices (AMD), Inc., of Sunnyvale, Calif., as well as any other suitable processor.

An operating system manages and controls the operation of the computer system 800, including the input and output of data to and from software applications (not shown). The operating system provides an interface between the software applications being executed on the system and the hardware components of the system. Any suitable operating system may be used, such as the LINUX Operating System, the Apple Macintosh Operating System, available from Apple Computer Inc. of Cupertino, Calif., UNIX operating systems, Microsoft® Windows® operating systems, BSD operating systems, and the like. Other implementations are possible.

The elements of the computer system 800 are described in greater detail below. In particular, the network interface 816 provides communication between the computer system 800 and any of a wide range of networks, such as an Ethernet (e.g., IEEE 802.3) network, a backplane, etc. The mass storage 818 provides permanent storage for the data and programming instructions to perform the above-described processes and features implemented by the respective computing systems identified above, whereas the system memory 814 (e.g., DRAM) provides temporary storage for the data and programming instructions when executed by the processor 802. The I/O ports 820 may be one or more serial and/or parallel communication ports that provide communication between additional peripheral devices, which may be coupled to the computer system 800.

The computer system 800 may include a variety of system architectures, and various components of the computer system 800 may be rearranged. For example, the cache 804 may be on-chip with processor 802. Alternatively, the cache 804 and the processor 802 may be packed together as a “processor module”, with processor 802 being referred to as the “processor core”. Furthermore, certain embodiments of the invention may neither require nor include all of the above components. For example, peripheral devices coupled to the standard I/O bus 808 may couple to the high performance I/O bus 806. In addition, in some embodiments, only a single bus may exist, with the components of the computer system 800 being coupled to the single bus. Moreover, the computer system 800 may include additional components, such as additional processors, storage devices, or memories.

In general, the processes and features described herein may be implemented as part of an operating system or a specific application, component, program, object, module, or series of instructions referred to as “programs”. For example, one or more programs may be used to execute specific processes described herein. The programs typically comprise one or more instructions in various memory and storage devices in the computer system 800 that, when read and executed by one or more processors, cause the computer system 800 to perform operations to execute the processes and features described herein. The processes and features described herein may be implemented in software, firmware, hardware (e.g., an application specific integrated circuit), or any combination thereof.

In one implementation, the processes and features described herein are implemented as a series of executable modules run by the computer system 800, individually or collectively in a distributed computing environment. The foregoing modules may be realized by hardware, executable modules stored on a computer-readable medium (or machine-readable medium), or a combination of both. For example, the modules may comprise a plurality or series of instructions to be executed by a processor in a hardware system, such as the processor 802. Initially, the series of instructions may be stored on a storage device, such as the mass storage 818. However, the series of instructions can be stored on any suitable computer readable storage medium. Furthermore, the series of instructions need not be stored locally, and could be received from a remote storage device, such as a server on a network, via the network interface 816. The instructions are copied from the storage device, such as the mass storage 818, into the system memory 814 and then accessed and executed by the processor 802. In various implementations, a module or modules can be executed by a processor or multiple processors in one or multiple locations, such as multiple servers in a parallel processing environment.

Examples of computer-readable media include, but are not limited to, recordable type media such as volatile and non-volatile memory devices; solid state memories; floppy and other removable disks; hard disk drives; magnetic media; optical disks (e.g., Compact Disk Read-Only Memory (CD ROMS), Digital Versatile Disks (DVDs)); other similar non-transitory (or transitory), tangible (or non-tangible) storage medium; or any type of medium suitable for storing, encoding, or carrying a series of instructions for execution by the computer system 800 to perform any one or more of the processes and features described herein.

For purposes of explanation, numerous specific details are set forth in order to provide a thorough understanding of the description. It will be apparent, however, to one skilled in the art that embodiments of the disclosure can be practiced without these specific details. In some instances, modules, structures, processes, features, and devices are shown in block diagram form in order to avoid obscuring the description. In other instances, functional block diagrams and flow diagrams are shown to represent data and logic flows. The components of block diagrams and flow diagrams (e.g., modules, blocks, structures, devices, features, etc.) may be variously combined, separated, removed, reordered, and replaced in a manner other than as expressly described and depicted herein.

Reference in this specification to “one embodiment”, “an embodiment”, “other embodiments”, “one series of embodiments”, “some embodiments”, “various embodiments”, or the like means that a particular feature, design, structure, or characteristic described in connection with the embodiment is included in at least one embodiment of the disclosure. The appearances of, for example, the phrase “in one embodiment” or “in an embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments, but also variously omitted in other embodiments. Similarly, various features are described that may be preferences or requirements for some embodiments, but not other embodiments.

The language used herein has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A computer-implemented method comprising:
acquiring, by a computing system, information associated with a user who is accessing a page within a social networking system, the page being associated with a page entity;
selecting, by the computing system, at least one call to action, out of a set of calls to action, based at least in part on the information associated with the user, the at least one call to action being associated with the page entity; and
presenting, by the computing system, to the user via the page within the social networking system, the at least one call to action.

2. The computer-implemented method of claim 1, wherein the selecting of the at least one call to action further comprises:
determining, based at least in part on the information associated with the user, a respective user relevance probability metric for each call to action in the set of calls to action;
determining that one or more calls to action are associated with one or more respective user relevance probability metrics that at least meet a specified user relevance probability threshold; and
identifying the at least one call to action to include the one or more calls to action associated with the one or more respective user relevance probability metrics that at least meet the specified user relevance probability threshold.

3. The computer-implemented method of claim 1, wherein the information associated with the user indicates at least one of an identity of the user, a gender of the user, an age of the user, a location associated with the user, an educational institution associated with the user, a professional institution associated with the user, a language associated with the user, or a relationship status of the user.

4. The computer-implemented method of claim 1, wherein the information associated with the user includes historical data associated with the user, and wherein the historical data is associated with at least one of a browsing history of the user, an application usage history of the user, or a social networking system usage history of the user.

5. The computer-implemented method of claim 4, wherein the social networking system usage history of the user indicates one or more social interactions performed by the user with respect to at least one content item posted via the social networking system.

6. The computer-implemented method of claim 5, wherein the one or more social interactions includes at least one of an up-vote, a comment, a share, or a save.

7. The computer-implemented method of claim 1, wherein the information associated with the user indicates that the user is part of a particular defined audience, wherein the selecting of the at least one call to action is further based at least in part on selection criteria, and wherein the selection criteria specify that the at least one call to action is to be selected for the particular defined audience.

8. The computer-implemented method of claim 1, wherein the information associated with the user is dynamically acquired, wherein the information associated with the user includes one or more updates, and wherein the selecting of the at least one call to action is performed dynamically based on the one or more updates.

9. The computer-implemented method of claim 1, wherein the presenting of the at least one call to action includes displaying the at least one call to action in association with at least one interactive element, and wherein the at least one interactive element is displayed within at least one of a cover photo of the page, an informational section of the page, a post published on the page, a hover element associated with the page, a search bar element associated with the page, or a search result element associated with the page.

10. The computer-implemented method of claim 1, wherein the presenting of the at least one call to action is performed using at least one of a website configured to communicate with the social networking system or an application configured to communicate with the social networking system.

11. A system comprising:
at least one processor; and
a memory storing instructions that, when executed by the at least one processor, cause the system to perform:
acquiring information associated with a user who is accessing a page within a social networking system, the page being associated with a page entity;
selecting at least one call to action, out of a set of calls to action, based at least in part on the information associated with the user, the at least one call to action being associated with the page entity; and
presenting, to the user via the page within the social networking system, the at least one call to action.

12. The system of claim 11, wherein the instructions cause the system to further perform:
determining, based at least in part on the information associated with the user, a respective user relevance probability metric for each call to action in the set of calls to action;
determining that one or more calls to action are associated with one or more respective user relevance probability metrics that at least meet a specified user relevance probability threshold; and
identifying the at least one call to action to include the one or more calls to action associated with the one or more respective user relevance probability metrics that at least meet the specified user relevance probability threshold.

13. The system of claim 11, wherein the information associated with the user indicates at least one of an identity of the user, a gender of the user, an age of the user, a location associated with the user, an educational institution associated with the user, a professional institution associated with the user, a language associated with the user, or a relationship status of the user.

14. The system of claim 11, wherein the information associated with the user includes historical data associated with the user, and wherein the historical data is associated with at least one of a browsing history of the user, an application usage history of the user, or a social networking system usage history of the user.

15. The system of claim 11, wherein the information associated with the user indicates that the user is part of a particular defined audience, wherein the selecting of the at least one call to action is further based at least in part on selection criteria, and wherein the selection criteria specify that the at least one call to action is to be selected for the particular defined audience.

16. A non-transitory computer-readable storage medium including instructions that, when executed by at least one processor of a computing system, cause the computing system to perform:
acquiring information associated with a user who is accessing a page within a social networking system, the page being associated with a page entity;
selecting at least one call to action, out of a set of calls to action, based at least in part on the information associated with the user, the at least one call to action being associated with the page entity; and
presenting, to the user via the page within the social networking system, the at least one call to action.

17. The non-transitory computer-readable storage medium of claim 16, wherein the instructions cause the system to further perform:
determining, based at least in part on the information associated with the user, a respective user relevance probability metric for each call to action in the set of calls to action;
determining that one or more calls to action are associated with one or more respective user relevance probability metrics that at least meet a specified user relevance probability threshold; and
identifying the at least one call to action to include the one or more calls to action associated with the one or more respective user relevance probability metrics that at least meet the specified user relevance probability threshold.

18. The non-transitory computer-readable storage medium of claim 16, wherein the information associated with the user indicates at least one of an identity of the user, a gender of the user, an age of the user, a location associated with the user, an educational institution associated with the user, a professional institution associated with the user, a language associated with the user, or a relationship status of the user.

19. The non-transitory computer-readable storage medium of claim 16, wherein the information associated with the user includes historical data associated with the user, and wherein the historical data is associated with at least one of a browsing history of the user, an application usage history of the user, or a social networking system usage history of the user.

20. The non-transitory computer-readable storage medium of claim 16, wherein the information associated with the user indicates that the user is part of a particular defined audience, wherein the selecting of the at least one call to action is further based at least in part on selection criteria, and wherein the selection criteria specify that the at least one call to action is to be selected for the particular defined audience.
